(19) United States
(12) Patent Application Publication
(10) Pub. No.: US 2025/0381604 A1
(43) Pub. Date: Dec. 18, 2025

(54) STEP DRILL BIT

(71) Applicant: MILWAUKEE ELECTRIC TOOL CORPORATION, Brookfield, WI (US)

(72) Inventors: Douglas W. Allen, Oconomowoc, WI (US); Courtney D. McCool, Menomonee Falls, WI (US); Smith C. Theiler, Plymouth, WI (US); Richard Hohnl, JR., Racine, WI (US)

(21) Appl. No.: 19/298,411

(22) Filed: Aug. 13, 2025

Related U.S. Application Data
(63) Continuation of application No. 16/831,995, filed on Mar. 27, 2020, now Pat. No. 12,434,308.
Application No. 16/831,995 is a division of application No. 16/250,175, filed on Jan. 17, 2019, now Pat. No. 10,695,845.
Application No. 16/250,175 is a continuation of application No. 15/668,874, filed on Aug. 4, 2017, now Pat. No. 10,252,351.
Application No. 15/668,874 is a division of application No. 14/297,777, filed on Jun. 6, 2014, now Pat. No. 9,731,358.
(60) Provisional application No. 61/831,926, filed on Jun. 6, 2013.

(51) Int. Cl. B23B 51/00; B23B 51/02

(52) U.S. Cl. CPC B23B 51/0081; B23B 51/009; B23B 51/02; B23B 51/00; B23B 2251/40; B23B 2251/52; B23B 2270/36; Y10T 408/21; Y10T 408/906

(57) ABSTRACT

A drill bit includes a shank extending along a bit axis and a body portion coupled to the shank. The body portion having a distal end and defining a plurality of axially stacked, progressively sized steps. The body portion defining a body flute having a flute surface. The drill bit includes a first indicium formed on the flute surface adjacent a first step of the plurality of steps, the first indicium including a number and an indicator band around the number and a second indicium formed on the flute surface adjacent a second step of the plurality of steps and spaced from the first indicium, the second indicium including a number and an indicator band around the number, wherein the first indicium is spaced from the second indicium by at least one step of the plurality of steps.

### CROSS-REFERENCE TO RELATED APPLICATIONS

This application is a continuation of U.S. application Ser. No. 16/831,995 filed Mar. 27, 2020, which is a divisional of U.S. patent application Ser. No. 16/250,175 (now U.S. Pat. No. 10,695,845), filed Jan. 17, 2019, which is a continuation of U.S. patent application Ser. No. 15/668,874 (now U.S. Pat. No. 10,252,351), filed Aug. 4, 2017, which is a divisional of U.S. patent application Ser. No. 14/297,777 (now U.S. Pat. No. 9,731,358), filed Jun. 6, 2014, and claims priority to U.S. Provisional Patent Application No. 61/831,926, filed Jun. 6, 2013, the entire contents of all of which are incorporated by reference herein.

### BACKGROUND

The present invention relates to power tool accessories. More specifically, the present invention relates to step drill bits.

Step drill bits are used in a variety of applications and industries where a user may need to drill holes through a thin-walled work piece. A step drill bit allows a user to drill holes in a progressive range of sizes with a single bit.

### SUMMARY

In some aspects, the techniques described herein relate to a drill bit including: a shank extending along a bit axis; a body portion coupled to the shank, the body portion having a distal end and defining a plurality of axially stacked, progressively sized steps including a foremost step at the distal end and a terminal step nearer the shank than the foremost step, the body portion further defining a body flute having a flute surface extending from the foremost step to the terminal step; a first indicium formed on the flute surface adjacent a first step of the plurality of steps, the first indicium including a number and an indicator band around the number; and a second indicium formed on the flute surface adjacent a second step of the plurality of steps and spaced from the first indicium, the second indicium including a number and an indicator band around the number; wherein the first indicium is spaced from the second indicium by at least one step of the plurality of steps.

In some aspects, the techniques described herein relate to a drill bit including: a shank extending along a bit axis; a body portion coupled to the shank, the body portion having a distal end and defining a plurality of axially stacked, progressively sized steps including a foremost step at the distal end and a terminal step nearer the shank than the foremost step, the body portion further defining a body flute extending from the foremost step to the terminal step; a first indicium formed on an outer surface of a first step of the plurality of steps; and a second indicium formed on an outer surface of a second step of the plurality of steps that is non-adjacent the first step of the plurality of steps; wherein at least one step of the body portion is positioned between the first step of the plurality of steps having the first indicium and the second step of the plurality of steps having the second indicium, the at least one step being without an indicium.

Other aspects of the invention will become apparent by consideration of the detailed description and accompanying drawings.

### BRIEF DESCRIPTION OF THE DRAWINGS

FIG. 1 is a side view of a step drill bit according to one embodiment of the invention.

FIG. 2 is another side view of the step drill bit of FIG. 1 rotated 90 degrees.

FIG. 3 is an enlarged top view of the step drill bit of FIG. 1.

FIG. 4 is an enlarged partial perspective view of a portion of the step drill bit of FIG. 1.

FIG. 5A is a cross-sectional view of the step drill bit of FIG. 2 taken along section line 5A-5A.

FIG. 5B is a cross-sectional view of the step drill bit of FIG. 1 taken along section line 5B-5B.

FIG. 6 is an enlarged, partial side view of a portion of the step drill bit of FIG. 1.

FIG. 7 is an enlarged, partial side view of a portion of the step drill bit of FIG. 2.

FIG. 8 is a side view of a step drill bit according to another embodiment of the invention.

FIG. 9 is another side view of the step drill bit of FIG. 8 rotated 90 degrees.

FIG. 10 is an enlarged top view of the step drill bit of FIG. 8.

FIG. 11 is an enlarged partial perspective view of a portion of the step drill bit of FIG. 8.

FIG. 12 is an enlarged, partial side view of a portion of the step drill bit of FIG. 9.

FIG. 13 is an enlarged, partial side view of a portion of the step drill bit of FIG. 9.

FIG. 14 is a side view of a step drill bit according to another embodiment of the invention.

FIG. 15 is a side view of the step drill bit of FIG. 14 rotated 90 degrees.

FIG. 16 is an enlarged top view of the step drill bit of FIG. 14.

FIG. 17 is an enlarged, partial side view of a portion of the step drill bit of FIG. 15.

FIG. 18 is a side view of a step drill bit according to another embodiment of the invention.

FIG. 19 is another side view of the step drill bit of FIG. 18 rotated 90 degrees.

FIG. 20 is an enlarged top view of the step drill bit of FIG. 18.

FIG. 21 is an enlarged, partial side view of a portion of the step drill bit of FIG. 19.

FIG. 22 is a side view of a step drill bit according to another embodiment of the invention.

FIG. 23 is another side view of the step drill bit of FIG. 22 rotated 90 degrees.

FIG. 24 is a bottom view of the step drill bit of FIG. 22.

FIG. 25 is a cross-sectional view of the step drill bit of FIG. 22 taken along section line 25-25.

FIG. 26 is an enlarged top view of the step drill bit of FIG. 22.

FIG. 27 is an enlarged, partial side view of a portion of the step drill bit of FIG. 23.

FIG. 28 is a side view of a step drill bit according to another embodiment of the invention.

FIG. 29 is another side view of the step drill bit of FIG. 28 rotated 90 degrees.

FIG. 30 is an enlarged top view of the step drill bit of FIG. 28.

FIG. 31 is an enlarged, partial side view of a portion of the step drill bit of FIG. 29.

FIG. 32 is a side view of a step drill bit according to another embodiment of the invention.

FIG. 33 is another side view of the step drill bit of FIG. 32 rotated 90 degrees.

FIG. 34 is an enlarged top view of the step drill bit of FIG. 32.

FIG. 35 is an enlarged, partial side view of a portion of the step drill bit of FIG. 33.

FIG. 36 is a side view of a step drill bit according to another embodiment of the invention.

FIG. 37 is another side view of the step drill bit of FIG. 36 rotated 90 degrees.

FIG. 38 is an enlarged top view of the step drill bit of FIG. 36.

FIG. 39 is an enlarged, partial side view of a portion of the step drill bit of FIG. 36.

FIG. 40 is a side view of a step drill bit according to another embodiment of the invention.

FIG. 41 is another side view of the step drill bit of FIG. 40 rotated 90 degrees.

FIG. 42 is an enlarged top view of the step drill bit of FIG. 40.

FIG. 43 is an enlarged, partial side view of a portion of the step drill bit of FIG. 41.

FIG. 44 is a side view of a step drill bit according to another embodiment of the invention.

FIG. 45 is another side view of the step drill bit of FIG. 44 rotated 90 degrees.

FIG. 46 is an enlarged top view of the step drill bit of FIG. 44.

FIG. 47 is an enlarged, partial side view of a portion of the step drill bit of FIG. 45.

FIG. 48 is a side view of a step drill bit according to another embodiment of the invention.

FIG. 49 is another side view of the step drill bit of FIG. 48 rotated 90 degrees.

FIG. 50 is an enlarged top view of the step drill bit of FIG. 48.

FIG. 51 is an enlarged, partial side view of a portion of the step drill bit of FIG. 49.

FIG. 52 is a perspective view of the step drill bit according to another embodiment of the invention.

FIG. 53 is tabulated performance data comparing the step drill bit of FIG. 1 to other step drill bits.

FIG. 54 is a schematic cross-sectional view of a step drill bit illustrating a jam-free design criteria.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

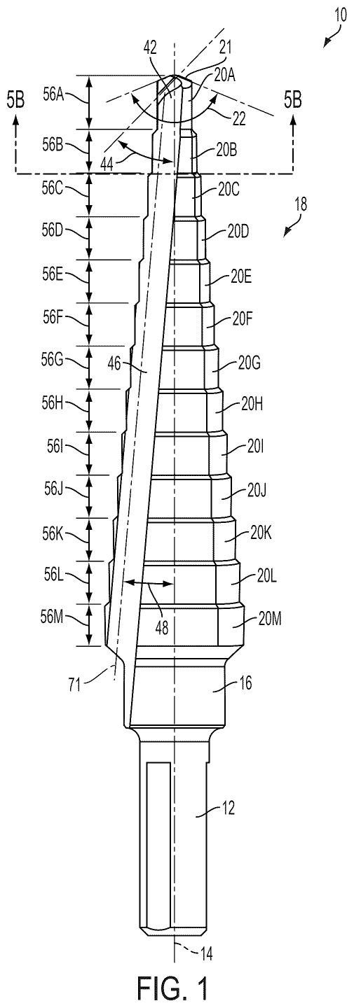

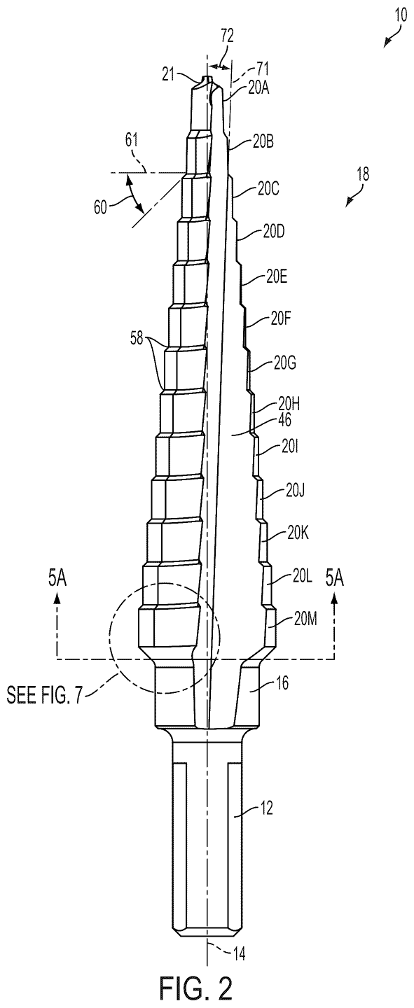

FIGS. 1 and 2 illustrate a step drill bit 10 including a shank 12, a transition portion 16, and a body portion 18. The shank 12 is configured to engage a power tool for rotation of the step drill bit 10 about a bit axis 14. The transition portion 16 is defined between the shank 12 and the body portion 18. The body portion 18 defines thirteen axially stacked, progressively sized steps 20A-20M between a bit tip 21 and the transition portion 16. The steps 20A-20M are axially stacked in that the steps 20A-20M are coaxially arranged along the bit axis 14. In addition, the steps 20A-20M are progressively sized in that the steps 20A-20M incrementally increase in size (e.g., diameter) from the bit tip 21, or distal end, of the body portion 18 to the transition portion 16.

As shown in FIG. 1, each of the thirteen steps 20A-20M of the body portion 18 has a step height 56A-56M. The step heights 56A-56M are not required to be the same for all steps. For example, in some embodiments, steps that correspond to commonly-used drill diameters (e.g., 0.5 inch, 0.75 inch, etc.) may have larger heights to allow a user to more easily control the step drill bit to stop at those corresponding steps. The illustrated steps include a first step 20A at the distal end of the body portion 18 and a terminal step 20M coupled to the transition portion 16. In the illustrated embodiment, the first step 20A has a diameter of approximately 0.125 inches, and the terminal step 20M has a diameter of approximately 0.505 inches. The intermediate steps 20B-20L located between the first and terminal steps 20A, 20M have incrementally increasing diameters within the range of 0.125 inches and 0.505 inches. In other embodiments, as further described below, the body portion 18 may include fewer or more steps, and/or each step 20A-20M may have a different diameter.

As shown in FIG. 2, a step chamfer 58 is formed between each pair of adjacent steps 20A-20M. The step chamfer 58 connects two adjacent steps at a ramp angle 60 to provide smoother transition between the adjacent steps. The ramp angle 60 is measured between a surface of the corresponding step chamfer 58 and a plane 61 extending perpendicular to the bit axis 14. In the illustrated embodiment, the ramp angle 60 for all of the step chamfers 58 is between approximately 40 degrees and approximately 50 degrees, and more specifically, approximately 45 degrees. In other embodiments, the ramp angle 60 may be relatively larger or smaller, or the step chamfers 58 may be omitted.

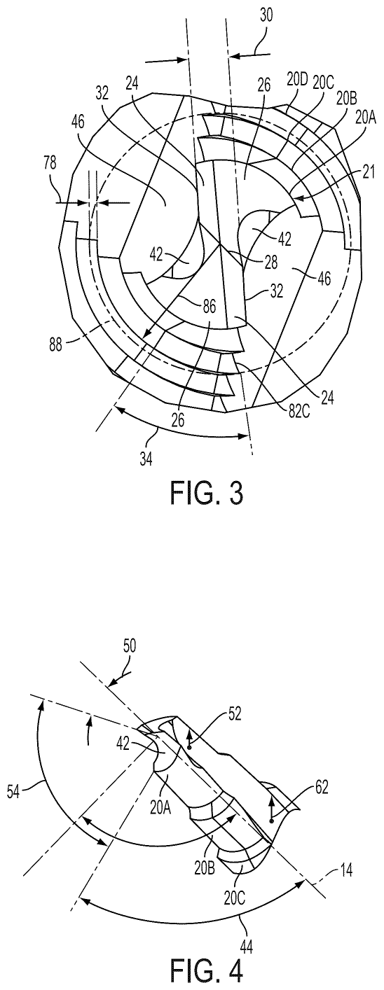

Referring back to FIG. 1, the bit tip 21 has a primary tip angle 22 measured through the bit axis 14 of between approximately 130 degrees and approximately 140 degrees, and more specifically, approximately 135 degrees. As shown in FIG. 3, the bit tip 21 is a dual-relief tip having two first chisel surfaces 24 and two second chisel surfaces 26. Each first chisel surface 24 is located on an opposite side of a chisel edge 28 of the bit tip 21 from a corresponding second chisel surface 26. The bit tip 21 defines a chisel width 30 measured between cutting edges 32 of the chisel surfaces 24, 26 of between approximately 0.022 inches and approximately 0.028 inches, and more specifically, approximately 0.025 inches. In other embodiments, the primary tip angle 22 and/or the chisel width 30 may be relatively larger or smaller.

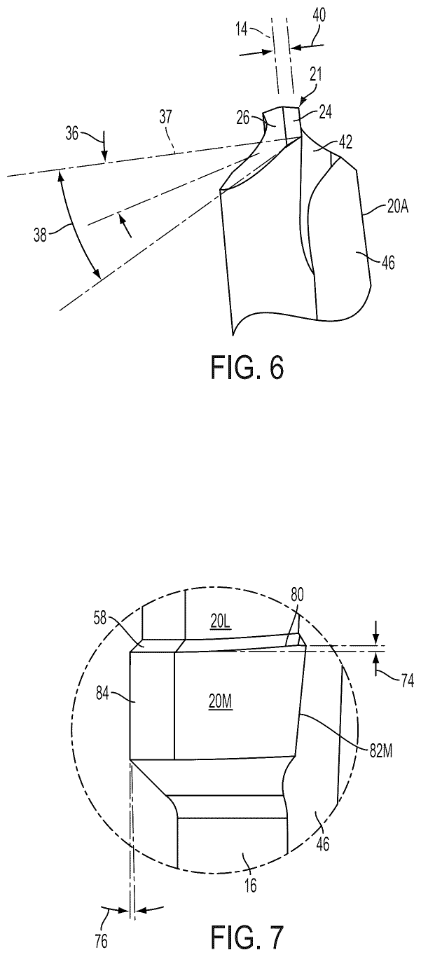

As shown in FIG. 6, each first chisel surface 24 has a first chisel surface width 40 of between approximately 0.012 inches and approximately 0.014 inches, and more specifically, approximately 0.013 inches. Each first chisel surface 24 also defines a first chisel relief angle 36, representing the slope of the first chisel surface 24 with respect to a reference axis 37 that is perpendicular to the bit axis 14. The first chisel relief angle 36 is between approximately 10 degrees and approximately 20 degrees, and more specifically, approximately 15 degrees. Each second chisel surface 26 defines a second chisel relief angle 38, representing the slope of the second chisel surface 26 with respect to the reference axis 37. The second chisel relief angle 38 is between approximately 25 degrees and approximately 35 degrees, and more specifically, approximately 30 degrees. In other embodiments, the chisel widths 40 and/or the chisel relief angles 36, 37 may be relatively larger or smaller.

Referring back to FIG. 3, the first step 20A further defines dual tip flutes 42 that extend to the bit tip 21. Each of the tip flutes 42 has a u-shaped cross-section with a tip flute radius 52 (FIG. 4) between approximately 0.035 inches and approximately 0.045 inches, and more specifically, approximately 0.045 inches. The tip flutes 42 are in the shape of an approximate quarter-circle, with the ends of the quarter-circle extending at an angle 54 between approximately 85 degrees and approximately 95 degrees, and more specifically, approximately 90 degrees. In other embodiments, the tip flute radii 52 and/or the angles 54 may be relatively larger or smaller.

With reference to FIGS. 1 and 4, each tip flute 42 is disposed at a compound angle with respect to the bit axis 14. The compound angle is defined by a first tip flute angle 44 (FIG. 1) and a second tip flute angle 50 (FIG. 4). The two tip flute angles 44, 50 exist in space in one plane, but are identified and measured by viewing the compound angle in two orthogonal planes. The first tip flute angle 44 is measured between a centerline of each tip flute 42 and the bit axis 14 as viewed from a first direction (i.e., from the viewpoint of FIG. 1). The second tip flute angle 50 is measured between the centerline of each tip flute 42 and the bit axis 14 as viewed from a second direction (i.e., from the viewpoint of FIG. 4). In the illustrated embodiment, each first tip flute angle 44 is between approximately 36 degrees and approximately 46 degrees with respect to the bit axis 14 as viewed in FIG. 1, and more specifically, approximately 41 degrees. In addition, each second tip flute angle 50 is between approximately 10 degrees and approximately 20 degrees with respect to the bit axis 14 as viewed in FIG. 4, and more specifically, approximately 15 degrees. In other embodiments, the first tip flute angles 44 and/or the second tip flute angles 50 may be relatively larger or smaller.

Referring to FIGS. 1-2, the body portion 18 defines two body flutes 46 disposed on diametrically opposite sides of the bit axis 14. Each body flute 46 extends from the first step 20A to the transition portion 16. Similar to the tip flutes 42, the body flutes 46 are disposed at compound angles with respect to the bit axis 14. As shown in FIG. 1, a first body flute angle 48 of each body flute 46 is measured between a centerline 71 of the body flute 46 as viewed from a first direction. As shown in FIG. 2, a second body flute angle 72 of each body flute is measured between the centerline 71 of the body flute 46 as viewed from a second direction that is different than the first direction (e.g., when the step drill bit 10 is rotated 90 degrees about the bit axis 14). In the illustrated embodiment, each first body flute angle 48 is between approximately 4.5 degrees and approximately 5.5 degrees with respect to the bit axis 14, and more specifically, approximately 5 degrees. In addition, each second body flute angle 72 is between approximately 1 degree and approximately 3 degrees with respect to the bit axis, and more specifically, approximately 2 degrees. In other embodiments, the first body flute angles 48 and/or the second body flute angles 72 may be relatively larger or smaller.

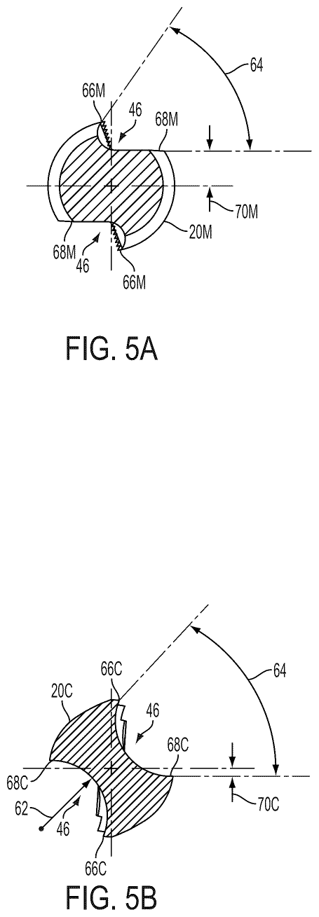

With reference to FIGS. 5A and 5B, each body flute 46 is formed with a body flute radius 62 of between approximately 0.06 inches and approximately 0.08 inches, and more specifically, approximately 0.07 inches. Each body flute 46 also defines a body flute span 64, which is measured between an edge 66 and a lip 68 of a corresponding step 20A-20M. In the illustrated embodiment, the body flute span 64 is between approximately 52.5 degrees and approximately 62.5 degrees, and more specifically, approximately 57.5 degrees. Depending on the step, the lip 68 is positioned at an offset 70 from the bit axis 14. The offset 70 may be different for each of the steps 20A-20M. For example, FIG. 5A illustrates the offset 70M for the terminal step 20M, which is approximately 0.14 inches in a first direction. In comparison, FIG. 5B illustrates the offset 70C for the third step 20C, which is approximately 0.01 inches in a second direction.

The thirteen steps 20A-20M of the step drill bit 10 each include three types of reliefs: an axial relief 74 (FIG. 7), a diametral relief 76 (FIG. 7), and a radial relief 78 (FIG. 3). As shown in FIG. 7, the axial relief 74 of each step 20A-20M is the amount by which an upper edge 80 of the step (i.e., the edge of the step closest to the distal end of the body portion 18) translates along the bit axis 14 toward the distal end as the upper edge 80 nears a leading edge 82 of the step (i.e., the edge of the step at the body flute 46). In the illustrated embodiment, the axial relief 74 of each step 20A-20M is between approximately 0.007 inches and approximately 0.013 inches, and more specifically, approximately 0.01 inches. In other embodiments, the axial relief 74 may be relatively larger or smaller.

With continued reference to FIG. 7, the diametral relief 76 of each step 20A-20M is the amount by which an outer circumferential surface 84 of the step tapers radially inward or outward along the bit axis 14. In the illustrated embodiment, the diametral relief 76 of each step 20A-20M is between approximately −1 degrees and approximately 0 degrees. In some embodiments, the diametral relief 76 may be omitted (i.e., may be 0 degrees). In other embodiments, the diametral relief 76 may be a relatively greater degree or may be positive.

With reference to FIG. 3, the radial relief 78 is the amount by which a radius 86 of the steps 20A-20M decreases as the outer surface of the step 20A-20M moves away from the leading edge 82. More particularly, a constant diameter circle 88 is illustrated in FIG. 3 in broken lines, representing the nominal diameter of the third step 20C. The radial relief 78 continuously increases along a radial relief angle 34 from the leading edge 82 of the step to a point at which the radial relief 78 has reached its maximum value or amount. As used herein, the “radial relief” is the maximum amount that the radius 86 of the step 20C decreases radially inward from the nominal diameter 88. In the illustrated embodiment, the radial relief 78 of each step 20A-20M is between approximately 0.002 inches and approximately 0.008 inches, and more specifically, approximately 0.005 inches. In addition, the radial relief angle 34 of each step 20A-20M is between approximately 40 degrees and approximately 50 degrees from the leading edge 82, and more specifically, approximately 45 degrees. In other embodiments, the radial relief 78 and/or the radial relief angle 34 may be relatively larger or smaller.

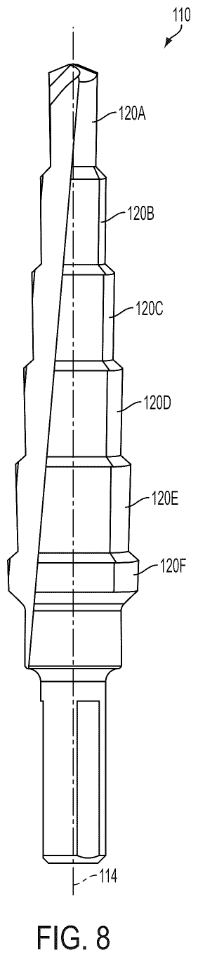

FIGS. 8-13 illustrate a step drill bit 110 according to another embodiment of the invention. The step drill bit 110 includes features similar to the step drill bit 10 of FIGS. 1-7, and like features have been given like reference numbers plus 100. The step drill bit 110 may include any combination of features, dimensions, or range of dimensions from the preceding or subsequent embodiments, but only features of the step drill bit 110 not yet discussed with respect to the previous embodiment are detailed below.

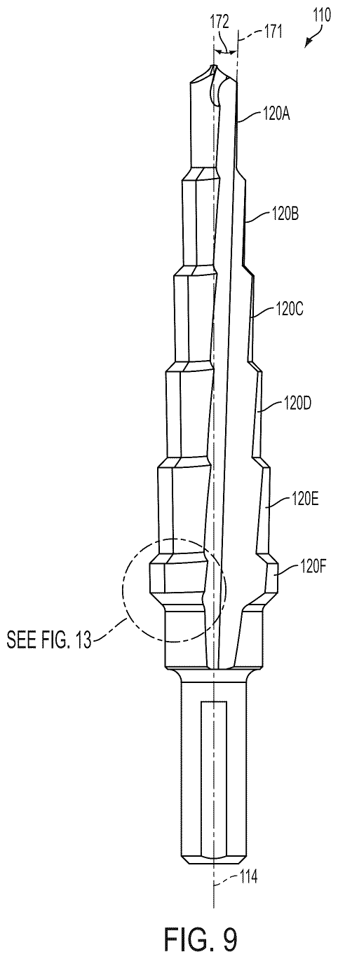

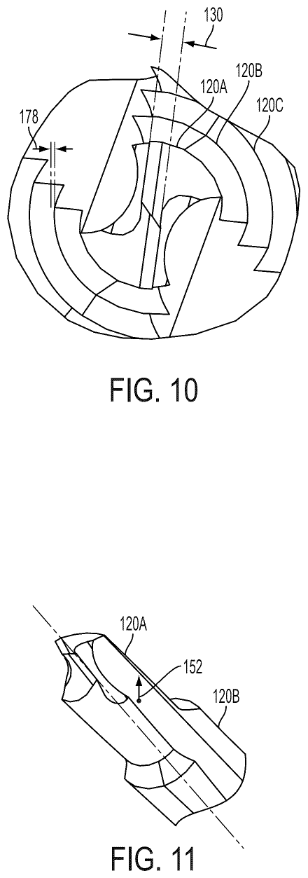

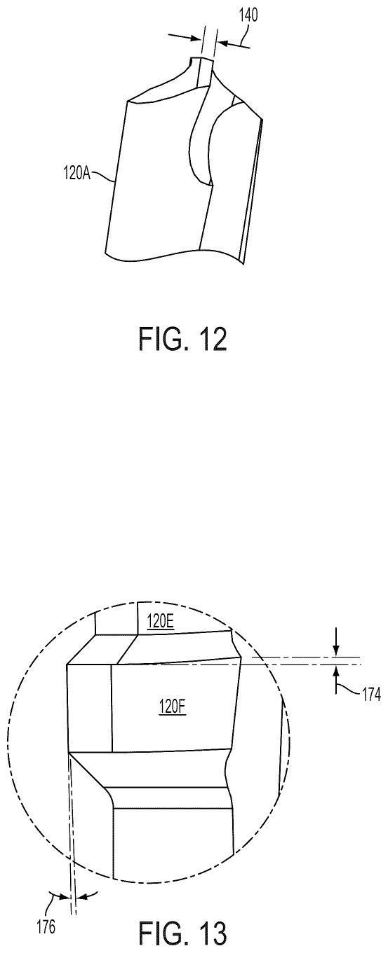

The step drill bit 110 includes six axially stacked, progressively sized steps 120A-120F. A first step 120A has a diameter of approximately 0.188 inches, and a terminal step 120F has a diameter of approximately 0.505 inches. With reference to FIG. 9, a second body flute angle 172, defined between a bit axis 114 and a centerline of the body flute radius 171 as viewed from FIG. 9, is between approximately 1.7 degrees and approximately 1.9 degrees, and more specifically, approximately 1.8 degrees. With reference to FIG. 10, the step drill bit 110 includes a chisel width 130 of between approximately 0.029 inches and approximately 0.035 inches, and more specifically, approximately 0.032 inches. With reference to FIG. 12, a first chisel surface width 140 is between approximately 0.011 inches and approximately 0.021 inches, and more specifically, approximately 0.016 inches. A tip flute radius 152 (FIG. 11) of the step drill bit 110 is between 0.055 inches and 0.075 inches, and more specifically, approximately 0.065 inches.

As shown in FIG. 10, the step drill bit 110 includes a radial relief 178 that is between approximately 0.002 inches and approximately 0.008 inches, and more specifically, approximately 0.005 inches. As shown in FIG. 13, the step drill bit 110 also includes a diametral relief 176 that is between approximately 0 degrees and approximately 1 degrees, and more specifically, approximately 1 degree. In addition, the step drill bit 110 includes an axial relief 174 that is between approximately 0.007 inches and approximately 0.013 inches, and more specifically, approximately 0.01 inches.

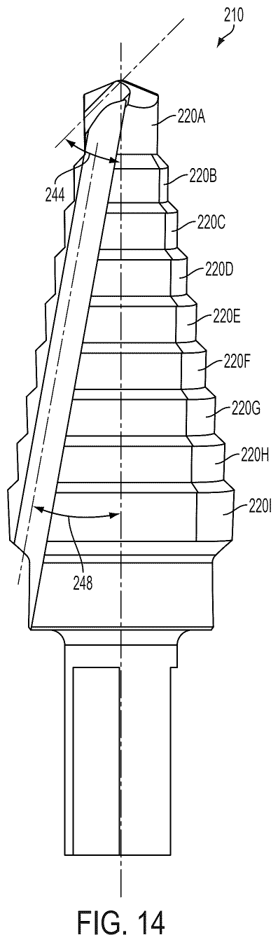

FIGS. 14-17 illustrate a step drill bit 210 according to another embodiment of the invention. The step drill bit 210 includes features similar to the step drill bit 10 of FIGS. 1-7, and like features have been given like reference numbers plus 200. The step drill bit 210 may include any combination of features, dimensions, or range of dimensions from the preceding or subsequent embodiments, but only features of the step drill bit 210 not yet discussed with respect to the previous embodiments are detailed below.

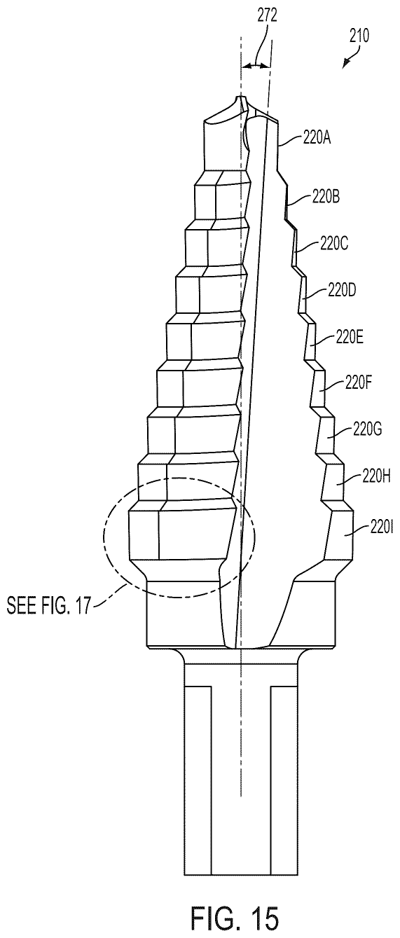

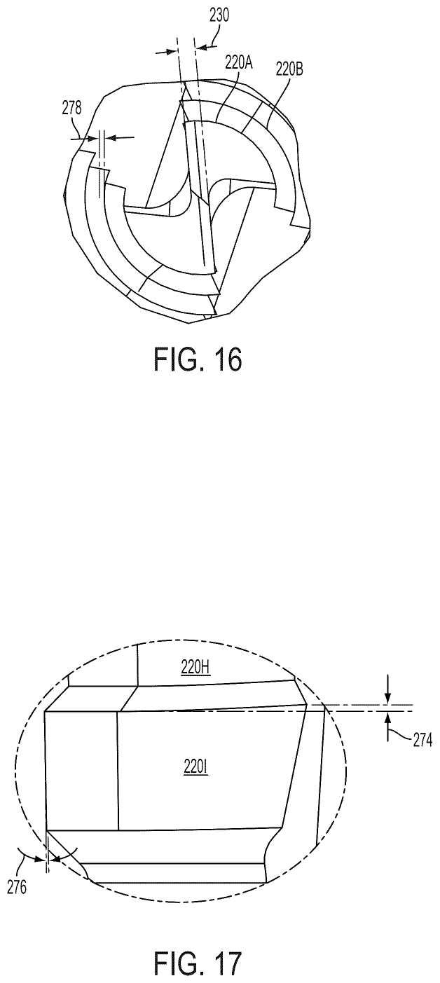

The step drill bit 210 includes nine axially stacked, progressively sized steps 220A-220I. A first step 220A has a diameter of approximately 0.255 inches, and a terminal step 220I has a diameter of approximately 0.755 inches. With reference to FIG. 14, a tip flute angle 244 is between approximately 54 degrees and approximately 64 degrees, and more specifically, approximately 59 degrees. In addition, a first body flute angle 248 is between approximately 9.2 degrees and approximately 11.2 degrees, and more specifically, approximately 10.2 degrees. With reference to FIG. 15, a second body flute angle 272 is between approximately 2.4 degrees and approximately 4.4 degrees, and more specifically, approximately 3.4 degrees. With reference to FIG. 16, the step drill bit 210 includes a chisel width 230 of between approximately 0.028 inches and approximately 0.034 inches, and more specifically, approximately 0.031 inches.

As shown in FIG. 16, the step drill bit 210 includes a radial relief 278 that is between approximately 0.002 inches and approximately 0.008 inches, and more specifically, approximately 0.005 inches. As shown in FIG. 17, the step drill bit 210 also includes a diametral relief 276 that is between approximately 0 degrees and approximately 1 degrees, and more specifically, approximately 0.5 degrees. In addition, the step drill bit 210 includes an axial relief 274 that is between approximately 0.007 inches and approximately 0.013 inches, and more specifically, approximately 0.01 inches.

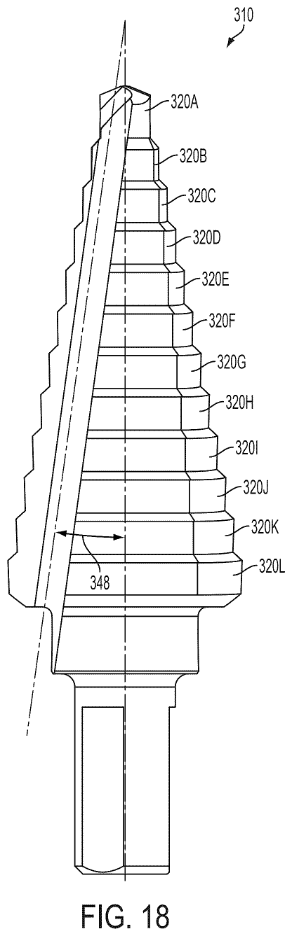

FIGS. 18-21 illustrate a step drill bit 310 according to another embodiment of the invention. The step drill bit 310 includes features similar to the step drill bit 10 of FIGS. 1-7, and like features have been given like reference numbers plus 300. The step drill bit 310 may include any combination of features, dimensions, or range of dimensions from the preceding or subsequent embodiments, but only features of the step drill bit 310 not yet discussed with respect to the previous embodiments are detailed below.

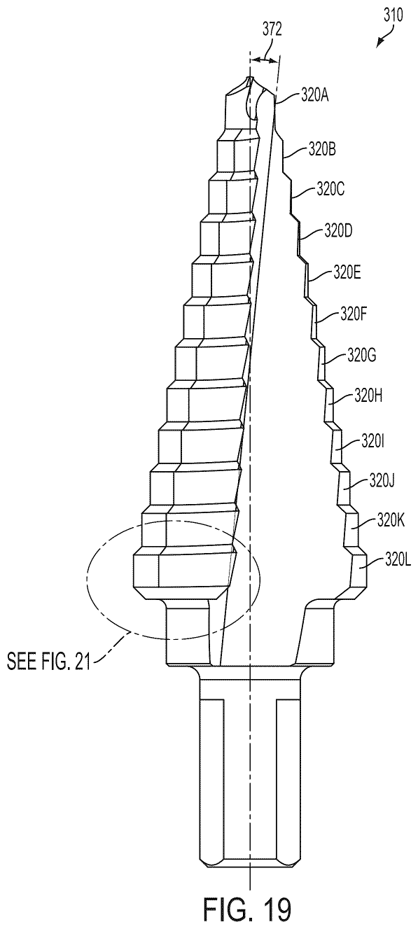

The step drill bit 310 includes twelve axially stacked, progressively sized steps 320A-320L. A first step 320A has a diameter of approximately 0.188 inches, and a terminal step 320L has a diameter of approximately 0.88 inches. With reference to FIG. 18, the step drill bit 310 includes a first body flute angle 348 that is between approximately 6.8 degrees and approximately 8.8 degrees, and more specifically, approximately 7.8 degrees. With reference to FIG. 19, the step drill bit 310 includes a second body flute angle 372 that is between approximately 4.6 degrees and approximately 6.6 degrees, and more specifically, approximately 5.6 degrees.

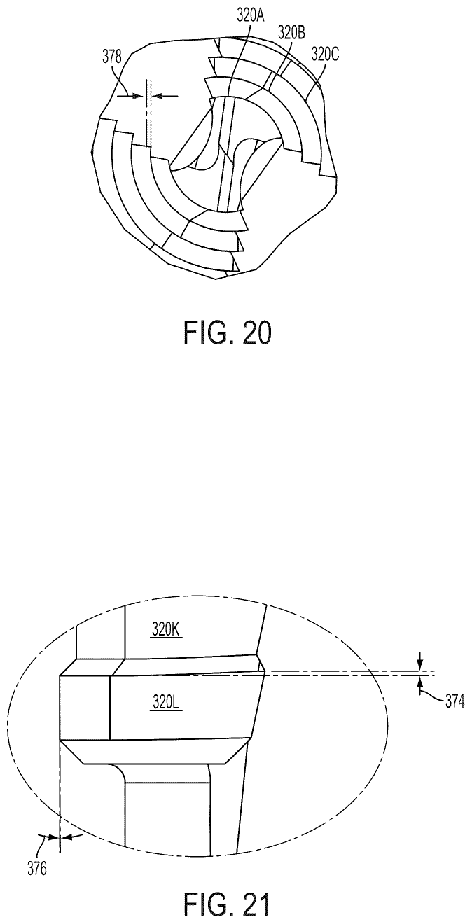

As shown in FIG. 20, the step drill bit 310 includes a radial relief 378 that is between approximately 0.002 inches and approximately 0.008 inches, and more specifically, approximately 0.005 inches. As shown in FIG. 21, the step drill bit 310 also includes a diametral relief 376 that is between approximately −1 degrees and approximately 0 degrees, and more specifically, approximately 0 degrees. In addition, the step drill bit 310 includes an axial relief 374 that is between approximately 0.007 inches and approximately 0.013 inches, and more specifically, approximately 0.01 inches.

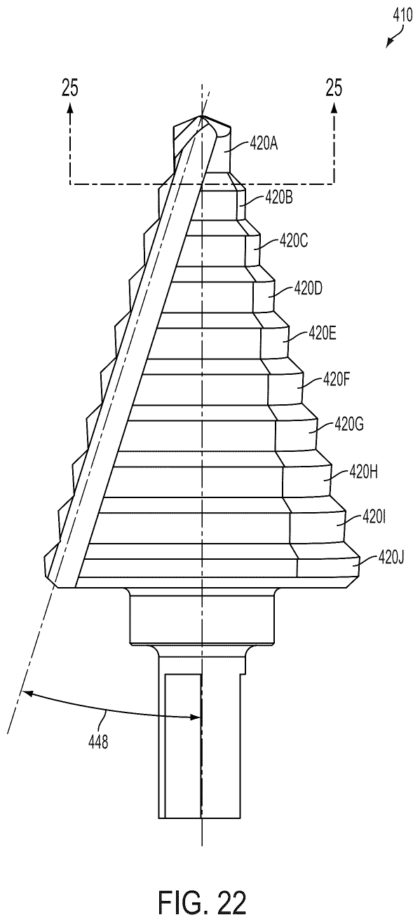

FIGS. 22-27 illustrate a step drill bit 410 according to another embodiment of the invention. The step drill bit 410 includes features similar to the step drill bit 10 of FIGS. 1-7, and like features have been given like reference numbers plus 400. The step drill bit 410 may include any combination of features, dimensions, or range of dimensions from the preceding or subsequent embodiments, but only features of the step drill bit 410 not yet discussed with respect to the previous embodiments are detailed below.

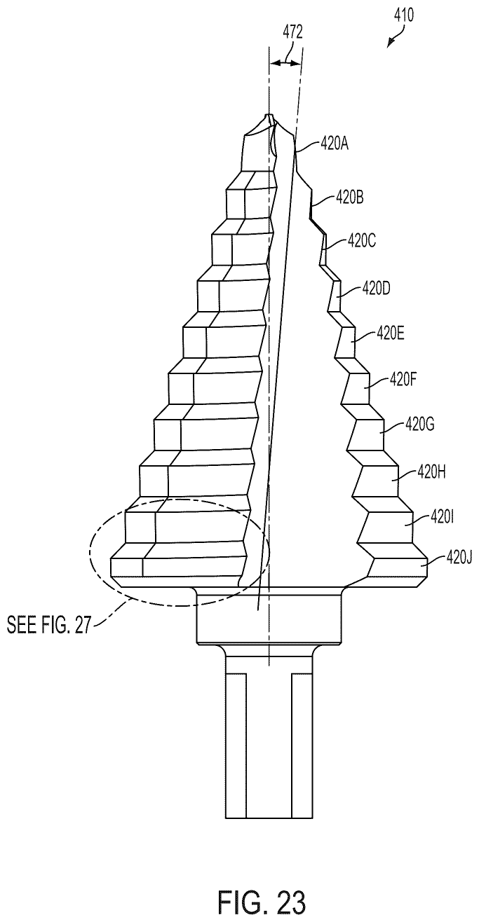

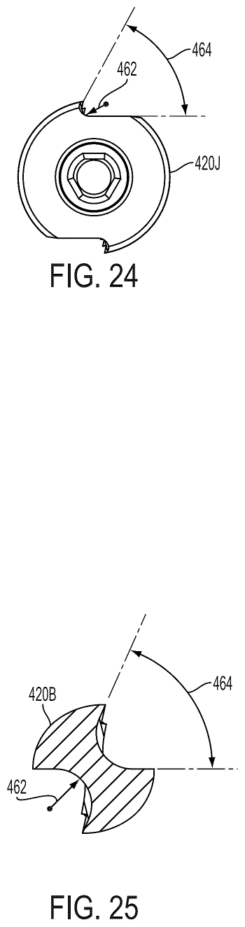

The step drill bit 410 includes ten axially stacked, progressively sized steps 420A-420J. A first step 420A has a diameter of approximately 0.25 inches, and a terminal step 420J has a diameter of approximately 1.38 inches. With reference to FIG. 22, the step drill bit 410 includes a first body flute angle 448 that is between approximately 16.4 degrees and approximately 18.4 degrees, and more specifically, approximately 17.4 degrees. With reference to FIG. 23, the step drill bit 410 includes a second body flute angle 472 that is between approximately 3.6 degrees and approximately 5.6 degrees, and more specifically, approximately 4.6 degrees. With reference to FIGS. 24 and 25, the step drill bit 410 includes a body flute radius 462 that is between approximately 0.084 inches and approximately 0.104 inches, and more specifically, approximately 0.094 inches. In addition, the step drill bit 410 includes a body flute span 464 that is between approximately 61 degrees and approximately 71 degrees, and more specifically, approximately 66 degrees.

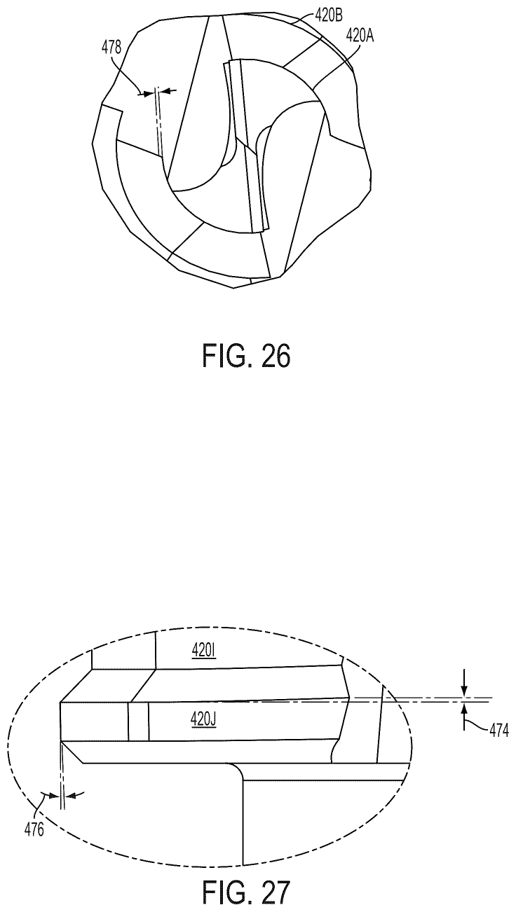

As shown in FIG. 26, the step drill bit 410 includes a radial relief 478 that is between approximately 0.002 inches and approximately 0.008 inches, and more specifically, approximately 0.005 inches. As shown in FIG. 27, the step drill bit 410 also includes a diametral relief 476 that is between approximately 0 degrees and approximately 1 degree, and more specifically, approximately 0.5 degrees. In addition, the step drill bit 410 includes an axial relief 474 that is between approximately 0.007 inches and approximately 0.013 inches, and more specifically, approximately 0.01 inches.

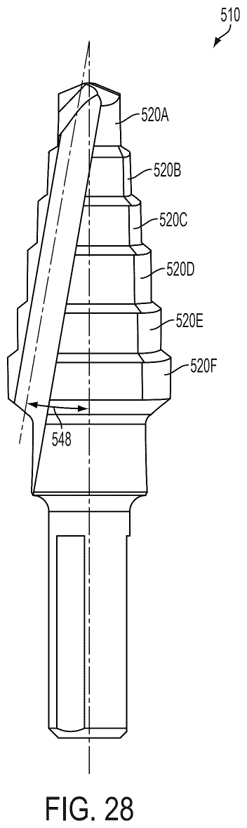

FIGS. 28-31 illustrate a step drill bit 510 according to another embodiment of the invention. The step drill bit 510 includes features similar to the step drill bit 10 of FIGS. 1-7, and like features have been given like reference numbers plus 500. The step drill bit 510 may include any combination of features, dimensions, or range of dimensions from the preceding or subsequent embodiments, but only features of the step drill bit 510 not yet discussed with respect to the previous embodiments are detailed below.

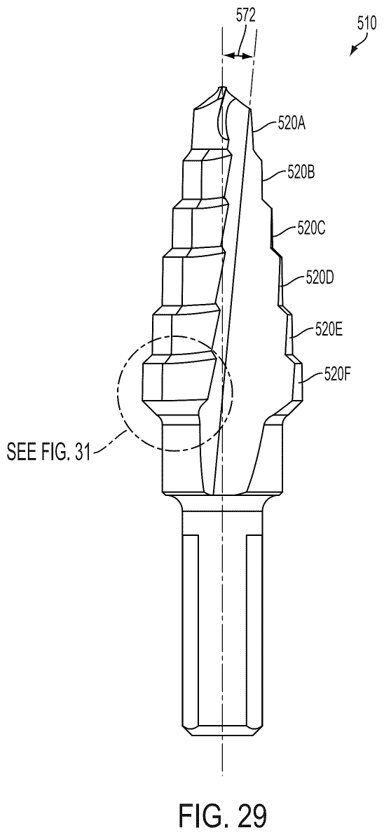

The step drill bit 510 includes six axially stacked, progressively sized steps 520A-520F. A first step 520A has a diameter of approximately 0.188 inches, and a terminal step 520F has a diameter of approximately 0.505 inches. With reference to FIG. 28, the step drill bit 510 includes a first body flute angle 548 that is between approximately 8.8 degrees and approximately 10.8 degrees, and more specifically, approximately 9.8 degrees. With reference to FIG. 29, the step drill bit 510 includes a second body flute angle 572 that is between approximately 4.3 degrees and approximately 6.3 degrees, and more specifically, approximately 5.3 degrees.

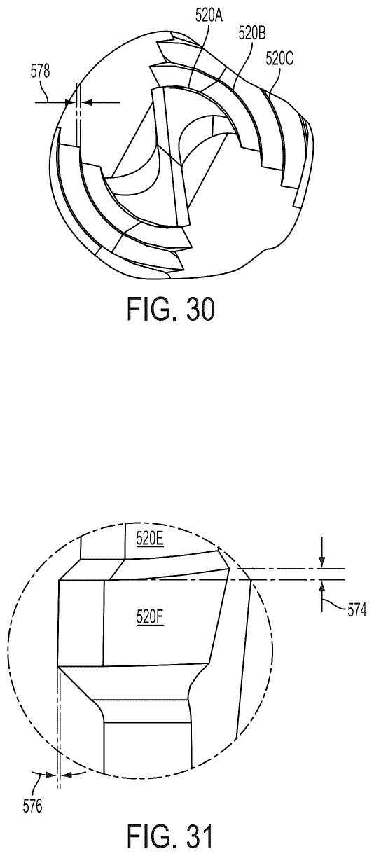

As shown in FIG. 30, the step drill bit 510 includes a radial relief 578 that is between approximately 0.002 inches and approximately 0.008 inches, and more specifically, approximately 0.005 inches. As shown in FIG. 31, the step drill bit 510 also includes a diametral relief 576 that is between approximately −1.5 degrees and approximately −0.5 degrees, and more specifically, approximately −1 degree. In addition, the step drill bit 510 includes an axial relief 574 that is between approximately 0.015 inches and approximately 0.021 inches, and more specifically, approximately 0.018 inches.

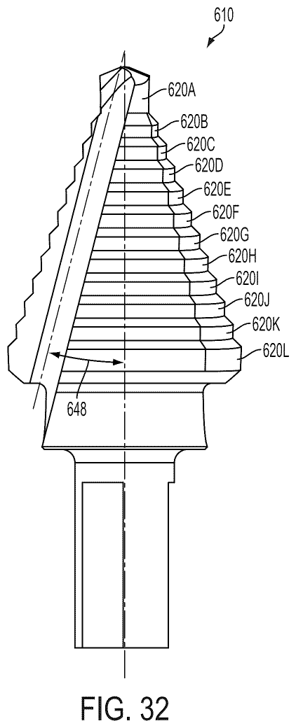

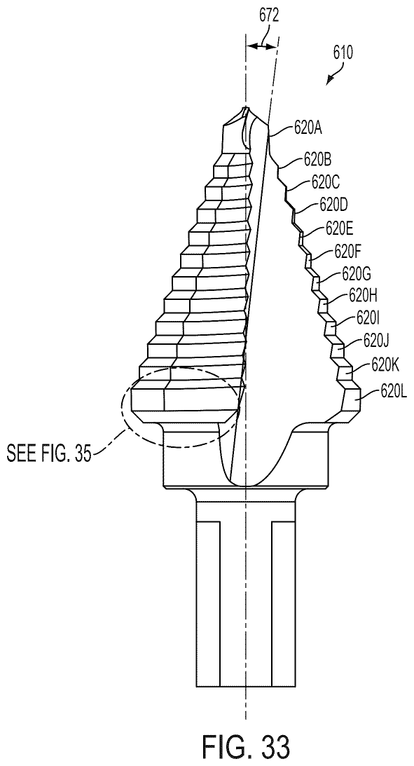

FIGS. 32-35 illustrate a step drill bit 610 according to another embodiment of the invention. The step drill bit 610 includes features similar to the step drill bit 10 of FIGS. 1-7, and like features have been given like reference numbers plus 600. The step drill bit 610 may include any combination of features, dimensions, or range of dimensions from the preceding or subsequent embodiments, but only features of the step drill bit 610 not yet discussed with respect to the previous embodiments are detailed below.

The step drill bit 610 includes twelve axially stacked, progressively sized steps 620A-620L. A first step 620A has a diameter of approximately 0.188 inches, and a terminal step 620L has a diameter of approximately 0.88 inches. With reference to FIG. 32, the step drill bit 610 includes a first body flute angle 648 between approximately 13.3 degrees and approximately 15.3 degrees, and more specifically, approximately 14.3 degrees. With reference to FIG. 33, the step drill bit 610 includes a second body flute angle 672 between approximately 5.3 degrees and approximately 7.3 degrees, and more specifically, approximately 6.3 degrees.

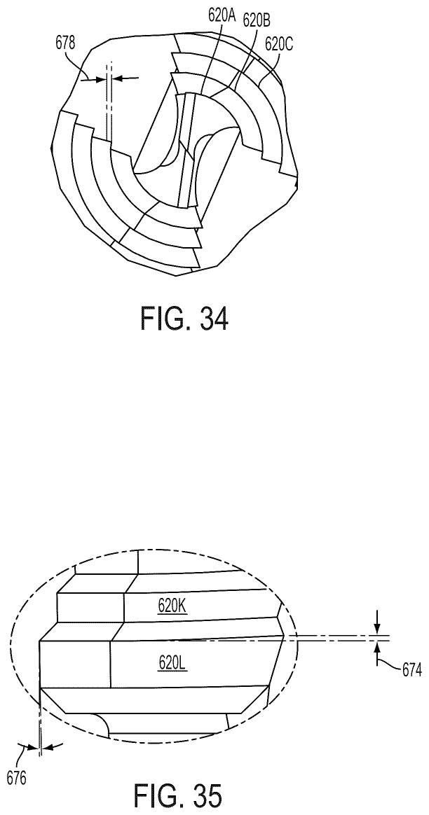

As shown in FIG. 34, the step drill bit 610 includes a radial relief 678 that is between approximately 0.002 inches and approximately 0.008 inches, and more specifically, approximately 0.005 inches. As shown in FIG. 35, the step drill bit 610 includes a diametral relief 676 that is between approximately 0 degrees and approximately 1 degree, and more specifically, approximately 0.5 degrees. In addition, the step drill bit 610 includes an axial relief 674 that is between approximately 0.007 inches and approximately 0.013 inches, and more specifically, approximately 0.01 inches.

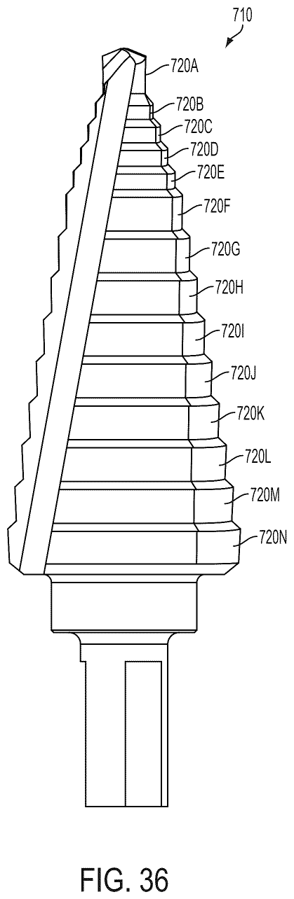

FIGS. 36-39 illustrate a step drill bit 710 according to another embodiment of the invention. The step drill bit 710 includes features similar to the step drill bit 10 of FIGS. 1-7, and like features have been given like reference numbers plus 700. The step drill bit 710 may include any combination of features, dimensions, or range of dimensions from the preceding or subsequent embodiments, but only features of the step drill bit 710 not yet discussed with respect to the previous embodiments are detailed below.

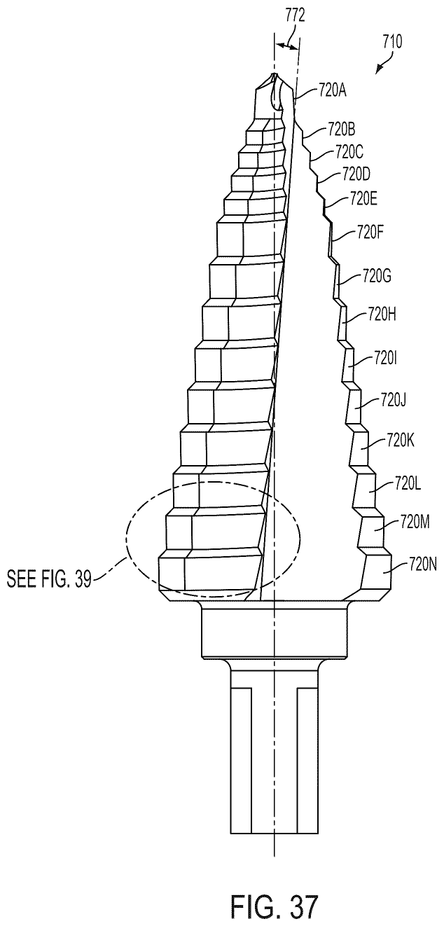

The step drill bit 710 includes fourteen axially stacked, progressively sized steps 720A-720N. A first step 720A has a diameter of approximately 0.188 inches, and a terminal step 720N has a diameter of approximately 1 inch. With reference to FIG. 37, the step drill bit 710 includes a second body flute angle 772 that is between approximately 3 degrees and approximately 5 degrees, and more specifically, approximately 4 degrees.

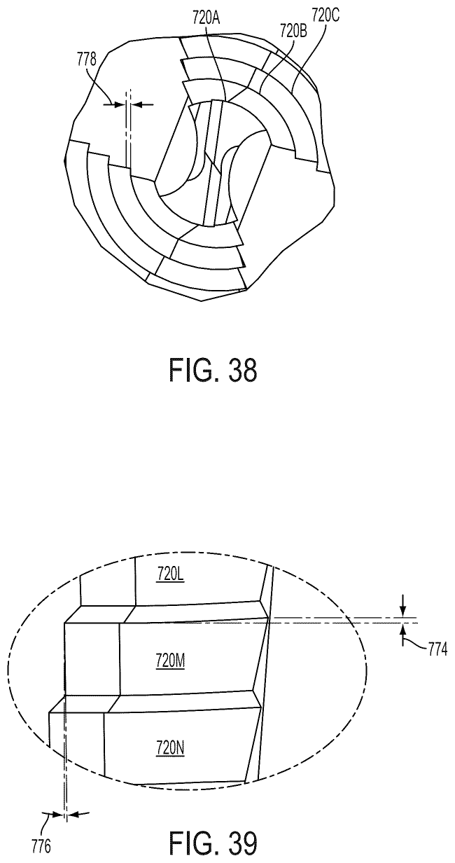

As shown in FIG. 38, the step drill bit 710 includes a radial relief 778 that is between approximately 0.002 inches and approximately 0.008 inches, and more specifically, approximately 0.005 inches. As shown in FIG. 39, the step drill bit 710 also includes a diametral relief 776 that is between approximately 0.5 degrees and approximately 1.5 degrees, and more specifically, approximately 1 degree. In addition, the step drill bit 710 includes an axial relief 774 that is between approximately 0.012 inches and approximately 0.018 inches, and more specifically, approximately 0.015 inches.

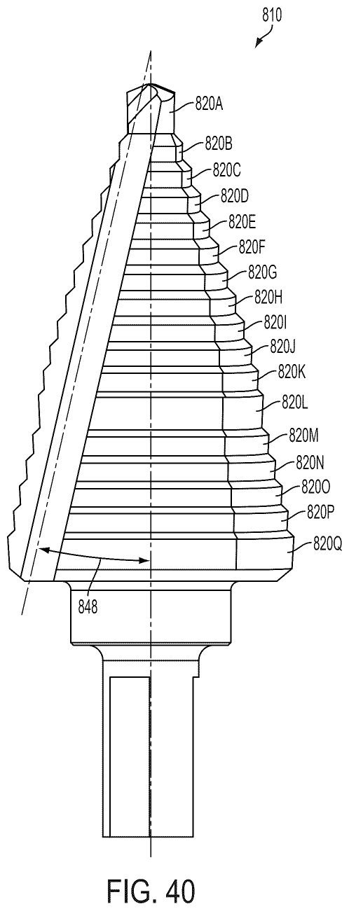

FIGS. 40-43 illustrate a step drill bit 810 according to another embodiment of the invention. The step drill bit 810 includes features similar to the step drill bit 10 of FIGS. 1-7, and like features have been given like reference numbers plus 800. The step drill bit 810 may include any combination of features, dimensions, or range of dimensions from the preceding or subsequent embodiments, but only features of the step drill bit 810 not yet discussed with respect to the previous embodiments are detailed below.

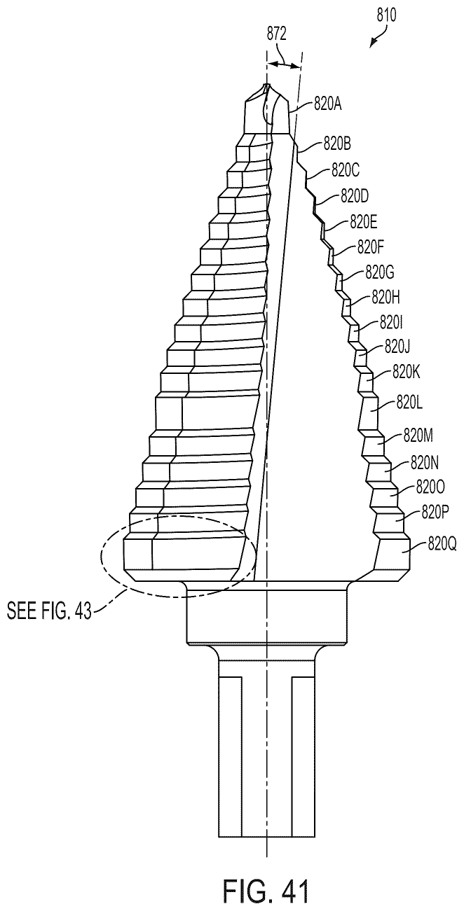

The step drill bit 810 includes seventeen axially stacked, progressively sized steps 820A-820Q. A first step 820A has a diameter of approximately 0.188 inches, and a terminal step 820Q has a diameter of approximately 1.13 inches. With reference to FIG. 40, the step drill bit 810 includes a first body flute angle 848 that is between approximately 12 degrees and approximately 14 degrees, and more specifically, approximately 13 degrees. With reference to FIG. 41, the step drill bit 810 includes a second body flute angle 872 between approximately 4.2 degrees and approximately 6.2 degrees, and more specifically, approximately 5.2 degrees.

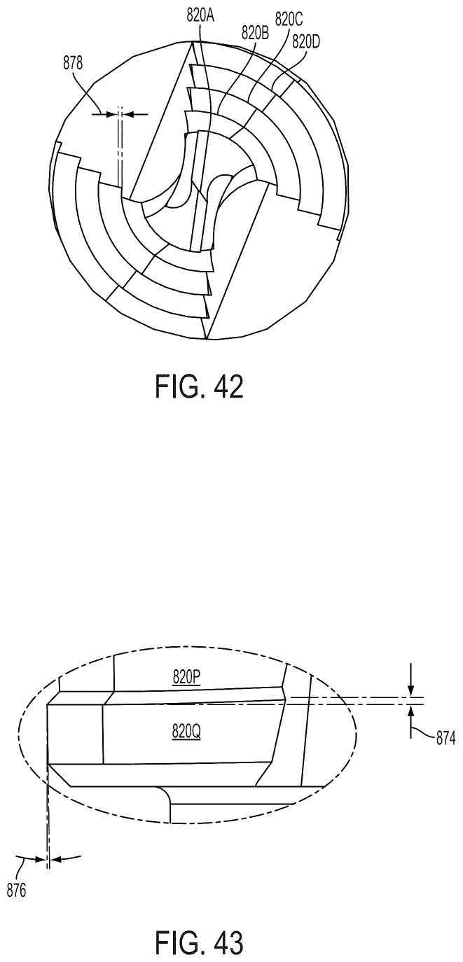

As shown in FIG. 42, the step drill bit 810 includes a radial relief 878 that is between approximately 0.002 inches and approximately 0.008 inches, and more specifically, approximately 0.005 inches. As shown in FIG. 43, the step drill bit 810 includes a diametral relief 876 that is between approximately 1 degree and approximately 2 degrees, and more specifically, approximately 1 degree. In addition, the step drill bit 810 includes an axial relief 874 between approximately 0.012 inches and approximately 0.018 inches, and more specifically, approximately 0.015 inches.

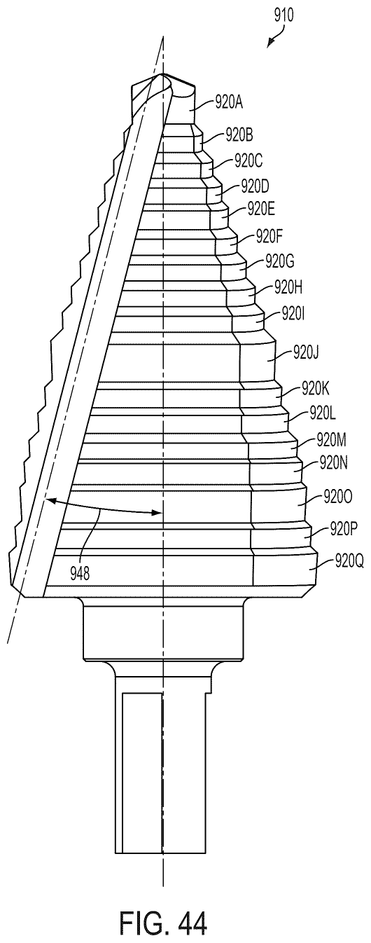

FIGS. 44-47 illustrate a step drill bit 910 according to another embodiment of the invention. The step drill bit 910 includes features similar to the step drill bit 10 of FIGS. 1-7, and like features have been given like reference numbers plus 900. The step drill bit 910 may include any combination of features, dimensions, or range of dimensions from the preceding or subsequent embodiments, but only features of the step drill bit 910 not yet discussed with respect to the previous embodiments are detailed below.

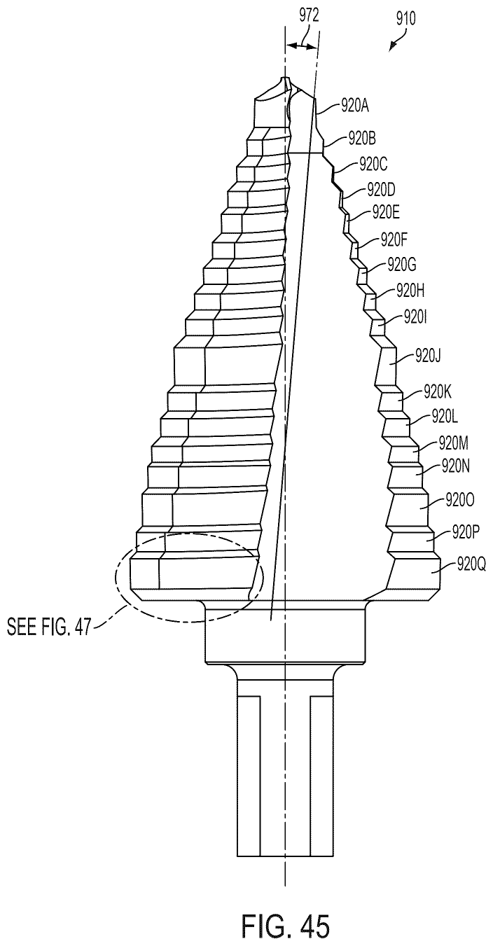

The step drill bit 910 includes seventeen axially stacked, progressively sized steps 920A-920Q. A first step 920A has a diameter of approximately 0.25 inches, and a terminal step 920Q has a diameter of approximately 1.224 inches. With reference to FIG. 44, the step drill bit 910 includes a first body flute angle 948 that is between approximately 13.4 degrees and approximately 15.4 degrees, and more specifically, approximately 14.4 degrees. With reference to FIG. 45, the step drill bit 910 includes a second body flute angle 972 that is between approximately 3.7 degrees and approximately 5.7 degrees, and more specifically, approximately 4.7 degrees.

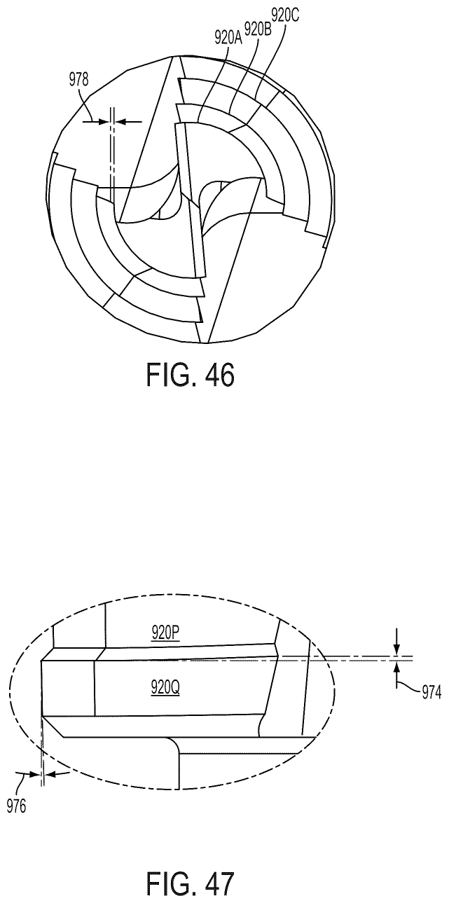

As shown in FIG. 46, the step drill bit 910 includes a radial relief 978 that is between approximately 0.002 inches and approximately 0.008 inches, and more specifically, approximately 0.005 inches. As shown in FIG. 47, the step drill bit 910 also includes a diametral relief 976 that is between approximately 0.5 degrees and approximately 1.5 degrees, and more specifically, approximately 1 degree. In addition, the step drill bit 910 includes an axial relief 974 that is between approximately 0.012 inches and approximately 0.018 inches, and more specifically, approximately 0.015 inches.

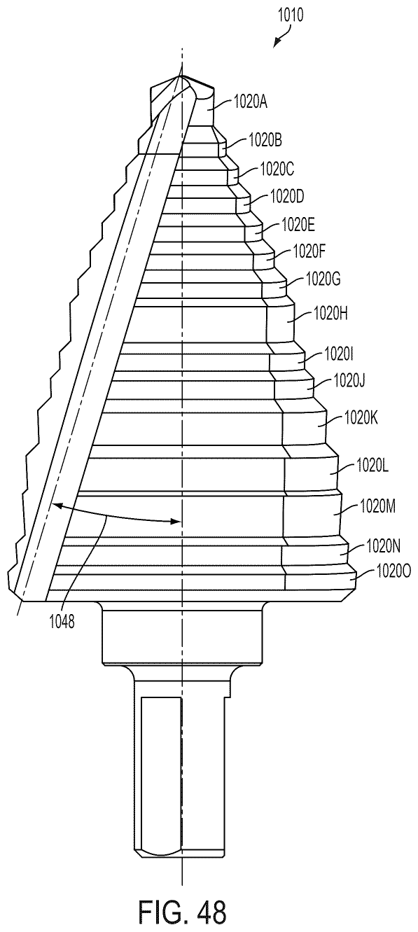

FIGS. 48-51 illustrate a step drill bit 1010 according to another embodiment of the invention. The step drill bit 1010 includes features similar to the step drill bit 10 of FIGS. 1-7, and like features have been given like reference numbers plus 1000. The step drill bit 1010 may include any combination of features, dimensions, or range of dimensions from the preceding or subsequent embodiments, but only features of the step drill bit 1010 not yet discussed with respect to the previous embodiments are detailed below.

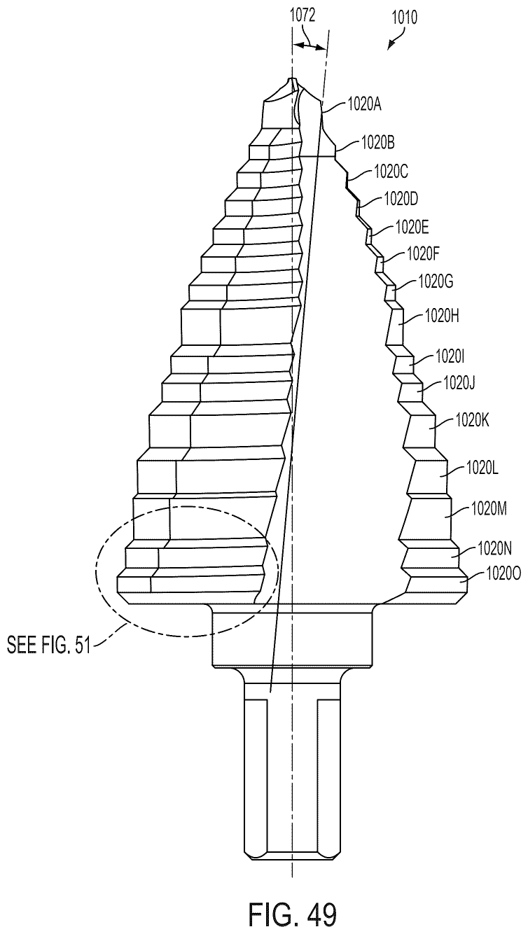

The step drill bit 1010 includes fifteen axially stacked, progressively sized steps 1020A-10200. A first step 1020A has a diameter of approximately 0.25 inches, and a terminal step 10200 has a diameter of approximately 1.38 inches. With reference to FIG. 48, the step drill bit 1010 includes a first body flute angle 1048 that is between approximately 15.7 degrees and approximately 17.7 degrees, and more specifically, approximately 16.7 degrees. With reference to FIG. 49, the step drill bit 1010 includes a second body flute angle 1072 that is between approximately 4.1 degrees and approximately 6.1 degrees, and more specifically, approximately 5.1 degrees.

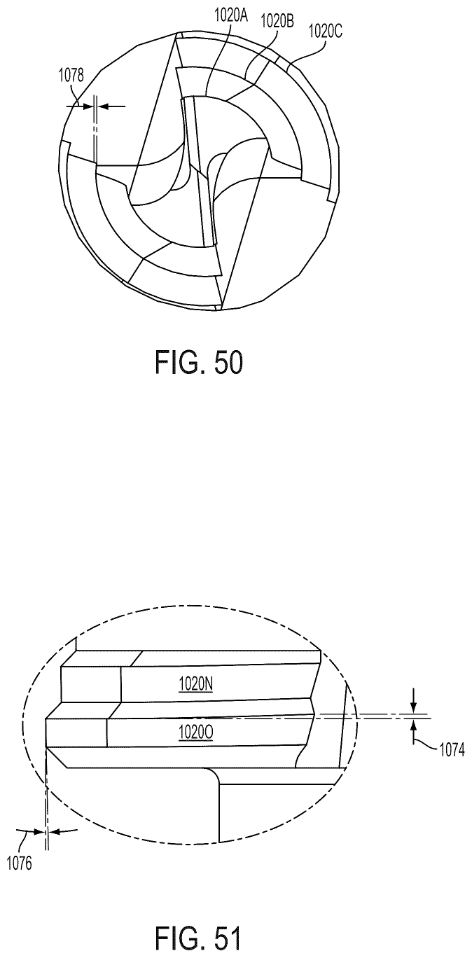

As shown in FIG. 50, the step drill bit 1010 includes a radial relief 1078 that is between approximately 0.002 inches and approximately 0.008 inches, and more specifically, approximately 0.005 inches. As shown in FIG. 51, the step drill bit 1010 also includes a diametral relief 1076 that is between approximately 0.5 degrees and approximately 1.5 degrees, and more specifically, approximately 1 degree. In addition, the step drill bit 1010 includes an axial relief 1074 that is between approximately 0.012 inches and approximately 0.018 inches, and more specifically, approximately 0.015 inches.

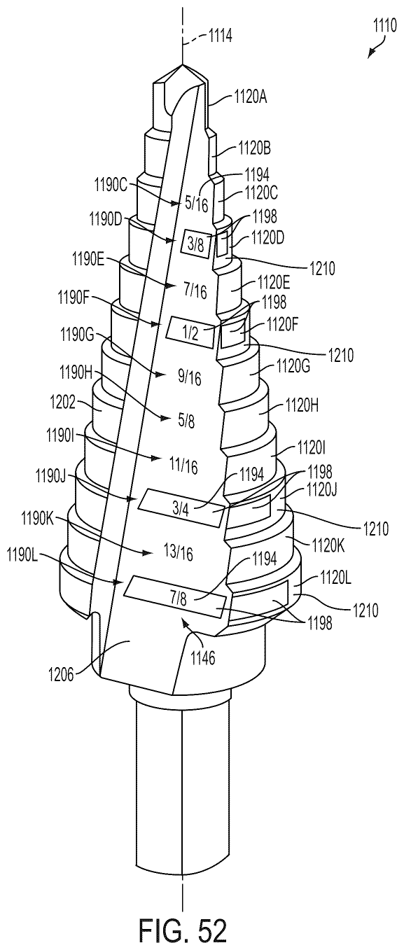

FIG. 52 illustrates a step drill bit 1110 according to another embodiment of the invention. The step drill bit 1110 includes features similar to the step drill bit 10 of FIGS. 1-7, and like features have been given like reference numbers plus 1100. The step drill bit 1110 may include any combination of features, dimensions, or range of dimensions from the preceding embodiments, but only features of the step drill bit 1110 not yet discussed with respect to previous embodiments are detailed below.

The step drill bit 1110 includes twelve axially stacked, progressively sized steps 1120A-1120L and at least one body flute 1146 extending through the steps 1120A-1120L. The step drill bit 1110 also includes indicia 1190C-1190L applied to each step 1120A-1120L. In some embodiments, the indicia 1190C-1190L are laser etchings formed in an outer surface 1202 of the step drill bit 1110. The indicia 1190C-1190L contrast with a surface finish of the step drill bit 1110 to facilitate viewing the indicia 1190C-1190L. For example, the step drill bit 1110 may have a black oxide finish, and the indicia 1190C-1190L may be appropriately colored (e.g., white) to sufficiently standout from the black oxide finish.

The illustrated indicia 1190C-1190L include numbers 1194 and indicator bands 1198. The numbers 1194 are indicative of diameters of the corresponding steps 1120A-1120L. In the illustrated embodiment, the numbers 1190 are formed on a flute surface 1206 that partially defines the body flute 1146. By placing the numbers 1194 on the flute surface 1206 and within the body flute 1146, the numbers 1194 are less exposed to wear during operation of the step drill bit 1110.

The indicator bands 1198 provide markings to help differentiate some of the indicia (e.g., the indicia 1190D, 1190F, 1190J, 1190L) from other indicia. The illustrated indicator bands 1198 are positioned on non-adjacent steps so that two steps directly next to each other in the stack of steps do not both have indicator bands. For example, in the illustrated embodiment, the indicator bands 1198 are positioned on steps 1120D, 1120F, 1120J, 1120L corresponding to commonly used hole diameters (e.g., ⅜ inch, ½ inch, ¾ inch, and ⅞ inch). As such, when the drill bit 1110 is rotated about bit axis 1114 at operational speeds (e.g., 200-2000 rpm), the indicator bands 1198 provide readily identifiable visible bands for these particular steps. In other embodiments, the indicator bands 1198 may be positioned on steps having other diameters.

In the illustrated embodiment, the indicator bands 1198 are provided on both the flute surface 1206 and the outer surfaces 1210 of the corresponding steps (e.g., the steps 1120D, 1120F, 1120J, 1120L). The illustrated indicator bands 1198 are discontinuous in the transition from the flute surface 1206 to the outer surfaces 1210, but may alternatively be formed as continuous bands. In addition, the illustrated indicator bands 1198 do not extend entirely around the outer surface 1210 of each corresponding step. Instead, the indicator bands 1198 only extend around a portion of each outer surface 1210. In some embodiments, the indicator bands 1198 extend around less than half of the outer surface 1210 of each step. In the illustrated embodiment, the indicator bands 1198 extend around less than a quarter of the outer surface 1210 of each step. In other embodiments, the indicator bands 1198 may be provided only on the flute surface 1206 or only on the outer surfaces 1210 of the corresponding steps.

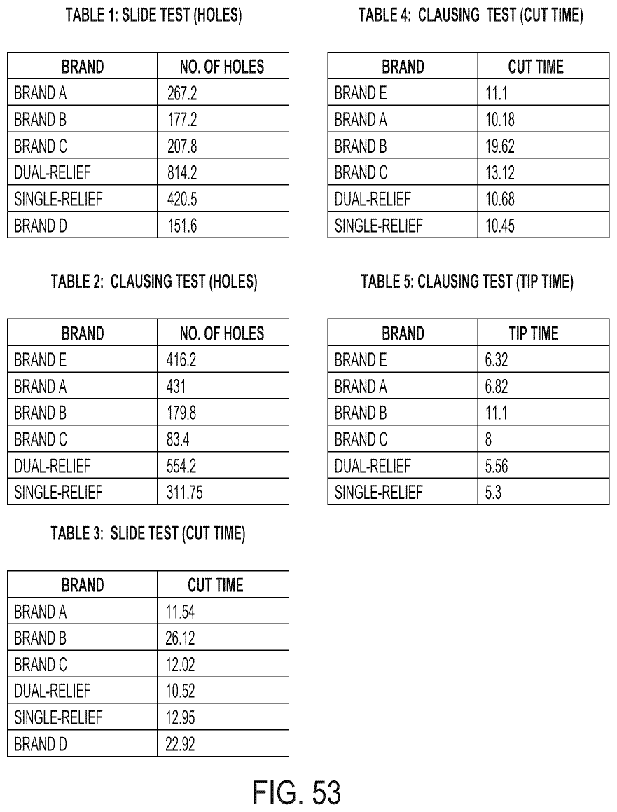

FIG. 53 provides tabulated data of a step drill bit according to the present invention. As shown in the tables, the step drill bit of the present invention provides improved performance when compared to competing products of comparable size. The test results for the step drill bit 10 are indicated as “Dual-Relief.” A similar step drill bit design with only a single relief bit tip is indicated as “Single-Relief,” and competitive designs are indicated by Brand A-E. The step drill bit 10 was tested under various testing conditions including a slide test (i.e., lower RPM testing) and a clausing test (i.e., higher RPM testing). Table 1 and Table 2 of FIG. 53 illustrate the number of holes drilled during life testing. Table 3 and Table 4 illustrate the time (in seconds) that it took to cut the holes identified in Tables 1 and 2. In addition, Table 5 illustrates the time it takes for a bit tip to penetrate a work piece for the clausing test. As noted in the tables, the step drill bit 10 has improved performance over the single relief bit tip design and the other brands with a larger number of holes drilled and shorter cut times under both testing conditions.

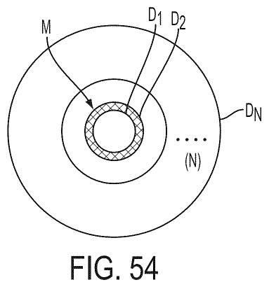

The increase in performance illustrated by FIG. 53 is due, in part, to step drill bits of the previously described embodiments adhering to a jam-resistant design. Especially where the step drill bit will be used with a cordless drill, jamming of the step drill bit may be significantly reduced by limiting the diameter difference between adjacent steps. With reference to FIG. 54, each step drill bit has a first step diameter D₁, a terminal step diameter D_{N}, and a total of N steps. The steps have progressively increasing diameters from the first step to the terminal step to achieve the terminal diameter D_{N} hole size. The number of steps N needed to achieve the finishing diameter D_{N} should be minimized to keep the bit compact (i.e., shorter along the bit rotational axis), while maintaining adequate axial length to allow for reasonable workpiece thickness. However, in order to achieve a jam-resistant design, an area of material M removed with each successive step should remain below a pre-determined threshold. The area of material M removed between adjacent steps is equal to the difference in hole cross-sectional areas defined by adjacent steps n and n−1 (i.e., M=¼ T (Dₙ²−Dₙ₋₁²)). In some embodiments, the difference in hole diameters formed by each pair of adjacent steps (which is the same as the difference in diameters of each pair of adjacent steps) is less than 0.1 inches. More specifically, the difference in hole diameters is approximately 0.0625 inches (or 1/16 inches).

The increase in performance illustrated in FIG. 53 is also partly due to the axial, diametral, and radial reliefs discussed above. The axial relief in particular helps increase feed rate of the step drill bit through a work piece. A larger axial relief generally increases the feed rate to, thereby, decrease the cut time for the step drill bit to drill the number of holes tabulated in FIG. 53.

Thus, the invention provides an improved step drill bit. Although the invention has been described with reference to certain preferred embodiments, variations and modifications exist within the scope and spirit of one or more independent aspects of the invention as described. Various features and advantages of the invention are set forth in the following claims.

What is claimed is:

1. A drill bit comprising:
a shank extending along a bit axis;
a body portion coupled to the shank, the body portion having a distal end and defining a plurality of axially stacked, progressively sized steps including a foremost step at the distal end and a terminal step nearer the shank than the foremost step, the body portion further defining a body flute having a flute surface extending from the foremost step to the terminal step;
a first indicium formed on the flute surface adjacent a first step of the plurality of steps, the first indicium including a number and an indicator band around the number; and
a second indicium formed on the flute surface adjacent a second step of the plurality of steps and spaced from the first indicium, the second indicium including a number and an indicator band around the number;
wherein the first indicium is spaced from the second indicium by at least one step of the plurality of steps.

2. The drill bit of claim 1, further comprising a transition portion extending from the shank.

3. The drill bit of claim 1, wherein the at least one step of the plurality of steps is without an indictor band.

4. The drill bit of claim 1, wherein the at least one step of the plurality of steps includes three adjacent steps of the body portion, each of the three adjacent steps being without an indicator band.

5. The drill bit of claim 1, wherein the first step of the plurality of steps has a diameter of ⅜ inch, ½ inch, ¾ inch, or ⅞ inch.

6. The drill bit of claim 1, wherein the number of the first indicium is indicative of a diameter of the first step, and wherein the number of the second indicium is indicative of a diameter of the second step.

7. The drill bit of claim 1, wherein the second step is the terminal step.

8. The drill bit of claim 1, wherein the first indicium and the second indicium contrasts with a surface finish of the flute surface.

9. The drill bit of claim 1, wherein the first indicium corresponds to an axial depth of the first step of the plurality of steps and the second indicium corresponds to an axial depth of the second step of the plurality of steps.

10. The drill bit of claim 1, wherein the first indicium and the second indicium include laser etchings in the flute surface.

11. The drill bit of claim 1, further comprising a third indicium formed on the flute surface that is spaced from the first indicium by at least a fourth step of the plurality of steps and spaced from the second indicium by at least a fifth step of the plurality of steps.

12. A drill bit comprising:
a shank extending along a bit axis;
a body portion coupled to the shank, the body portion having a distal end and defining a plurality of axially stacked, progressively sized steps including a foremost step at the distal end and a terminal step nearer the shank than the foremost step, the body portion further defining a body flute extending from the foremost step to the terminal step;
a first indicium formed on an outer surface of a first step of the plurality of steps; and
a second indicium formed on an outer surface of a second step of the plurality of steps that is non-adjacent the first step of the plurality of steps;
wherein at least one step of the body portion is positioned between the first step of the plurality of steps having the first indicium and the second step of the plurality of steps having the second indicium, the at least one step being without an indicium.

13. The drill bit of claim 12, further comprising a transition portion extending from the shank.

14. The drill bit of claim 12, wherein the one of the plurality of steps has a diameter of ⅜ inch, ½ inch, ¾ inch, or ⅞ inch.

15. The drill bit of claim 12, wherein the first indicium includes a first indicator band and the second indicium includes a second indicator band.

16. The drill bit of claim 12, wherein the first indicium extends around less than a quarter of the outer surface of the first step, and wherein the second indicium extends around less than a quarter of the outer surface of the second step.

17. The drill bit of claim 12, wherein the second step of the plurality of steps is the terminal step.

18. The drill bit of claim 12, wherein the first indicium and the second indicium contrasts with a surface finish of the body portion.

19. The drill bit of claim 12, wherein the first indicium corresponds to an axial depth of the first step of the plurality of steps and the second indicium corresponds to an axial depth of the second step of the plurality of steps.

20. The drill bit of claim 12, further comprising a third indicium formed on an outer surface of a third step of the plurality of steps that is non-adjacent the first step of the plurality of steps and the second step of the plurality of steps.
